(19) United States
(12) Patent Application Publication
(10) Pub. No.: US 2013/0127744 A1
(43) Pub. Date: May 23, 2013

(54) WIREFRAME TOUCH SENSOR DESIGN AND SPATIALLY LINEARIZED TOUCH SENSOR DESIGN

(71) Applicants: Jyotindra Raj Shakya, Sunnyvale, CA (US); Russel Allyn Martin, Menlo Park, CA (US)

(72) Inventors: Jyotindra Raj Shakya, Sunnyvale, CA (US); Russel Allyn Martin, Menlo Park, CA (US)

(73) Assignee: QUALCOMM MEMS TECHNOLOGIES, INC., San Diego, CA (US)

(21) Appl. No.: 13/463,602

(22) Filed: May 3, 2012

Related U.S. Application Data
(60) Provisional application No. 61/562,671, filed on Nov. 22, 2011.

(51) Int. Cl. G06F 3/041

(52) U.S. Cl. 345/173; 178/18.03

(57) ABSTRACT

A touch sensor may include thin, conductive wires as at least some of the sensor electrodes. Some or all of the conductive wires may be metal wires. The sensor electrodes may not be noticeable to a human observer. In some such implementations, the sensor electrodes may be laid out in a pattern and/or grouped to create a spatial gradient. Some such implementations involve spatial interweaving, spatial interposing and/or length modulation of sensor electrodes. Such implementations can create a spatial gradient such that fewer rows and columns are required to provide a touch sensor panel with a given level of accuracy.

### PRIORITY CLAIM

This application claims priority to U.S. Provisional Patent Application No. 61/562,671, filed on Nov. 22, 2011 and entitled “WIREFRAME TOUCH SENSOR DESIGN AND SPATIALLY LINEARIZED TOUCH SENSOR DESIGN” (Attorney Docket QUALP111P/113185P1), which is hereby incorporated by reference in its entirety and for all purposes.

### TECHNICAL FIELD

This disclosure relates to display devices, including but not limited to display devices that incorporate touch screens.

### DESCRIPTION OF THE RELATED TECHNOLOGY

Electromechanical systems (EMS) include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Currently, touch sensors made to overlay display devices generally have sensor electrodes made from indium tin oxide (ITO), because ITO is substantially transparent. Although transparency is a very desirable attribute, ITO has other properties that are not optimal.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus which includes a touch sensor. The touch sensor may include thin, conductive wires as the sensor electrodes. Some or all of the conductive wires may be metal wires. The sensor electrodes may not be noticeable to a human observer. In some such implementations, the sensor electrodes may be laid out in a pattern and/or grouped to create a spatial gradient. Some such implementations involve spatial interweaving, spatial interposing and/or length modulation of sensor electrodes. Such implementations can create a spatial gradient such that relatively fewer rows and columns are required to provide a touch sensor panel with a given level of accuracy.

Another innovative aspect of the subject matter described in this disclosure can be implemented in an apparatus that includes a touch sensor device. The touch sensor device may include a plurality of row electrodes formed substantially in a plane. Each row electrode of the plurality of row electrodes may have a plurality of row branches extending laterally from the row electrode. The row branches may be spatially interwoven with adjacent row branches of an adjacent row electrode.

The apparatus also may include a plurality of column electrodes formed substantially in the plane. First groups of the plurality of column electrodes may be ganged together and spatially interposed with second groups of the plurality of column electrodes. At least some of the column electrodes may include column branches that extend laterally from a first column electrode and between adjacent row branches.

The column branches may connect the first column electrode to a second column electrode. A first plurality of the row branches may have a first length and a second plurality of the row branches may have a second length. In some implementations, the first and second groups of column electrodes may be grouped in a 1-2-1 pattern, a 2-4-2 pattern, a 1-2-3-2-1 pattern or a 1-2-3-4-3-2-1 pattern.

In some implementations, the plurality of row electrodes and/or the plurality of column electrodes may be formed, at least in part, of metal wire. However, in some implementations the plurality of row electrodes and/or the plurality of column electrodes may be formed, at least in part, of indium tin oxide.

The apparatus also may include a display and a processor that is configured to communicate with the display. The processor may be configured to process image data. The apparatus also may include a memory device that is configured to communicate with the processor. The apparatus may include a driver circuit configured to send at least one signal to the display and a controller configured to send at least a portion of the image data to the driver circuit. The apparatus may include an image source module configured to send the image data to the processor. The image source module may include at least one of a receiver, transceiver, and transmitter. The apparatus may include an input device configured to receive input data and to communicate the input data to the processor. The apparatus may include a touch controller configured for communication with the processor and routing wires configured for connecting the row electrodes and the column electrodes with the touch controller.

Another innovative aspect of the subject matter described in this disclosure can be implemented in an apparatus that includes a touch sensor device. The apparatus may include a first plurality of row electrodes formed substantially in a plane. Each first row electrode of the plurality of first row electrodes may have a plurality of first row branches extending laterally from the first row electrode.

The apparatus may include a second plurality of row electrodes formed substantially in the plane. Each second row electrode of the plurality of second row electrodes may have a plurality of second row branches extending laterally from the second row electrode. The second row branches may be spatially interwoven with adjacent first row branches of an adjacent first row electrode. The first row branches may have a plurality of first row branch lengths. At least some of the first row branch lengths may vary proportionally with second row branch lengths of adjacent second row branches.

There may be a variable distance between the first plurality of row electrodes and the second plurality of row electrodes. The first plurality of row electrodes may include substantially parallel line segments. The second plurality of row electrodes may include first substantially parallel line segments and second substantially parallel line segments. The first substantially parallel line segments may be disposed at an angle from the second substantially parallel line segments. The apparatus may have first areas that include the first substantially parallel line segments and second areas adjacent to the first areas. The second areas may include the second substantially parallel line segments.

The first row branches may extend from the first plurality of row electrodes on a first side and a second side. The first row branches on the first side may have first lengths that are proportional to second lengths of the first row branches on the second side.

In some implementations, the second row branches may extend from the second plurality of row electrodes on a first side and a second side. The second row branches on the first side may have first lengths that are inversely proportional to second lengths of the second row branches on the second side.

The apparatus may include a plurality of column electrodes. In some implementations, at least some of the first plurality of row electrodes may be connected to the column electrodes. The first plurality of row electrodes, the second plurality of row electrodes and/or the plurality of column electrodes may be formed, at least in part, of metal wire. The plurality of column electrodes may include loops. The loops may enclose at least one of the second row branches.

Details of one or more implementations of the subject matter described in this specification are set forth in the accompanying drawings and the description below. Although the examples provided in this summary are primarily described in terms of MEMS-based displays, the concepts provided herein may apply to other types of displays, such as liquid crystal displays, organic light-emitting diode (“OLED”) displays and field emission displays. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a touch sensor having spatially interposed row electrodes and column electrodes.

FIG. 10A shows an example of a touch sensor having spatially interwoven row electrodes and spatially interposed column electrodes.

FIGS. 10B shows an enlarged portion of the touch sensor example of FIG. 10A.

FIG. 11 shows an example of a touch sensor having spatially interwoven row electrodes and column electrodes.

FIG. 12A shows an example of a touch sensor having a mat mosaic design of row electrodes and column electrodes.

FIG. 12B shows an enlarged portion of the touch sensor example of FIG. 12A.

FIG. 13 shows an example of a touch sensor having two sets of spatially interwoven row electrodes.

FIGS. 14A and 14B show examples of system block diagrams illustrating a display device that includes a touch sensor as described herein.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

According to some implementations provided herein, the metal sensor electrodes of a touch sensor may be formed of small, finely-spaced conductive wires. Some or all of the conductive wires may be metal wires. In some implementations, the sensor electrodes may not be noticeable to a human observer. In some such implementations, the sensor electrodes may be laid out in a pattern and/or grouped to create a spatial gradient.

Some such implementations involve spatial interweaving, wherein branches from adjacent sensor electrode rows and/or columns extend into each other. Such implementations may cause a gradual change in a mutual capacitance signal when a finger or a conductive stylus moves across the touch sensor. Alternatively, or additionally, some implementations involve spatial interposing of sensor electrodes, wherein the rows and/or columns can be ganged on the periphery to create groups of sensor electrodes that overlap with adjacent groups of sensor electrodes.

Some implementations involve length modulation of sensor electrodes. First row electrodes may have row branches on a first side with lengths that are inversely proportional to the lengths of row branches on a second side. Second row electrodes may have row branches on a first side with lengths that are proportional to the lengths of row branches on a second side. According to some such implementations, a spatial gradient may be created by interleaving row branches of the first row electrodes with adjacent row branches of the second row electrodes.

Particular implementations of the subject matter described in this disclosure can be implemented to realize one or more of the following potential advantages. Some implementations can create a spatial gradient such that relatively fewer rows and columns of sensor electrodes are required to provide a touch sensor panel with a given level of accuracy. Because some of the signal interpolation is due to an inherent gradient caused by the sensor design, signals from fewer nodes need to be processed. Such implementations can reduce computational complexity, memory requirements and power consumption.

An example of a suitable electromechanical systems (EMS) or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

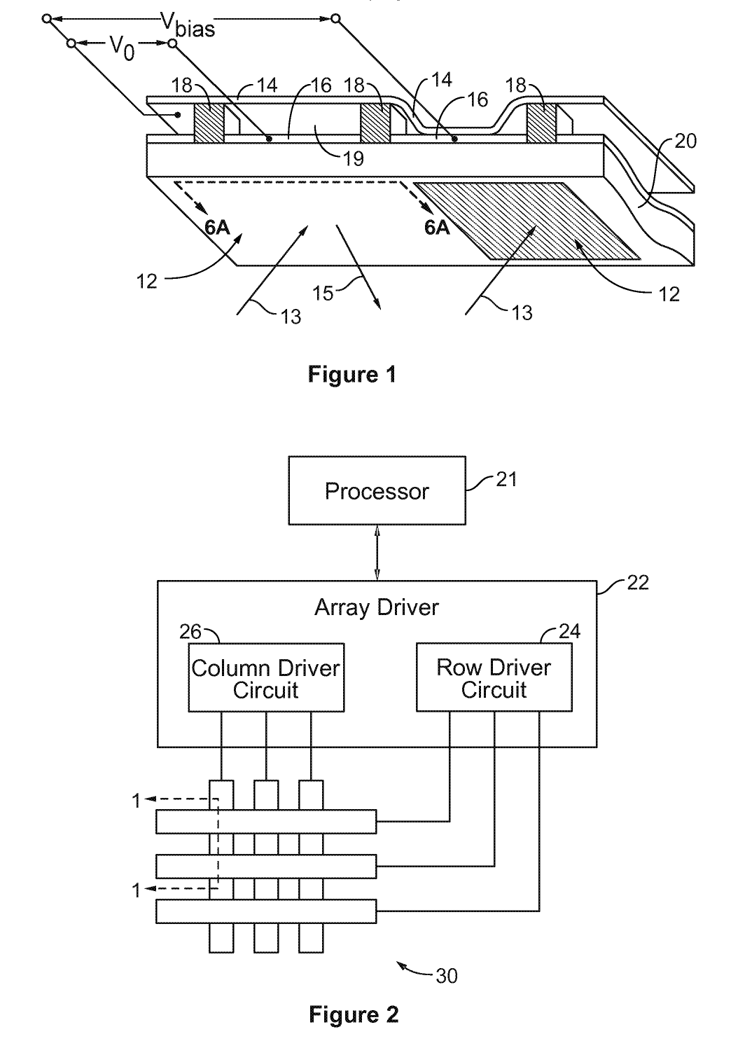

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the IMOD 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the IMOD 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the IMOD 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated IMOD 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

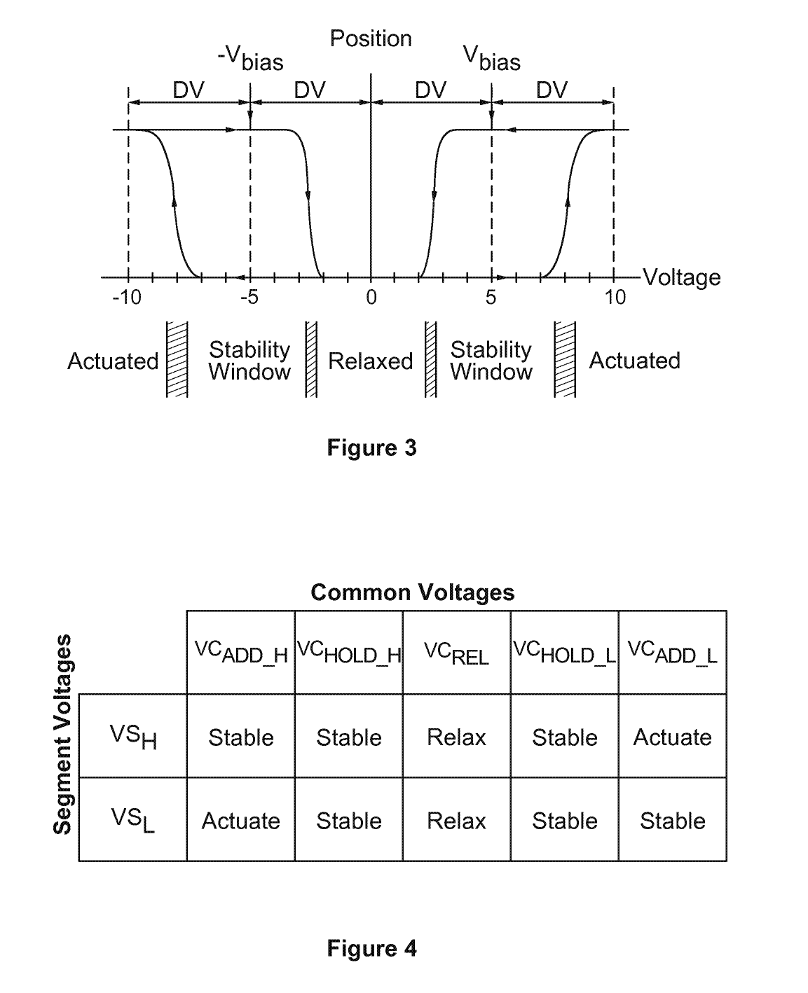

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10 volts. However, the movable reflective layer does not relax completely until the voltage drops below 2 volts. Thus, a range of voltage, approximately 3 to 7 volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10 volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7 volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

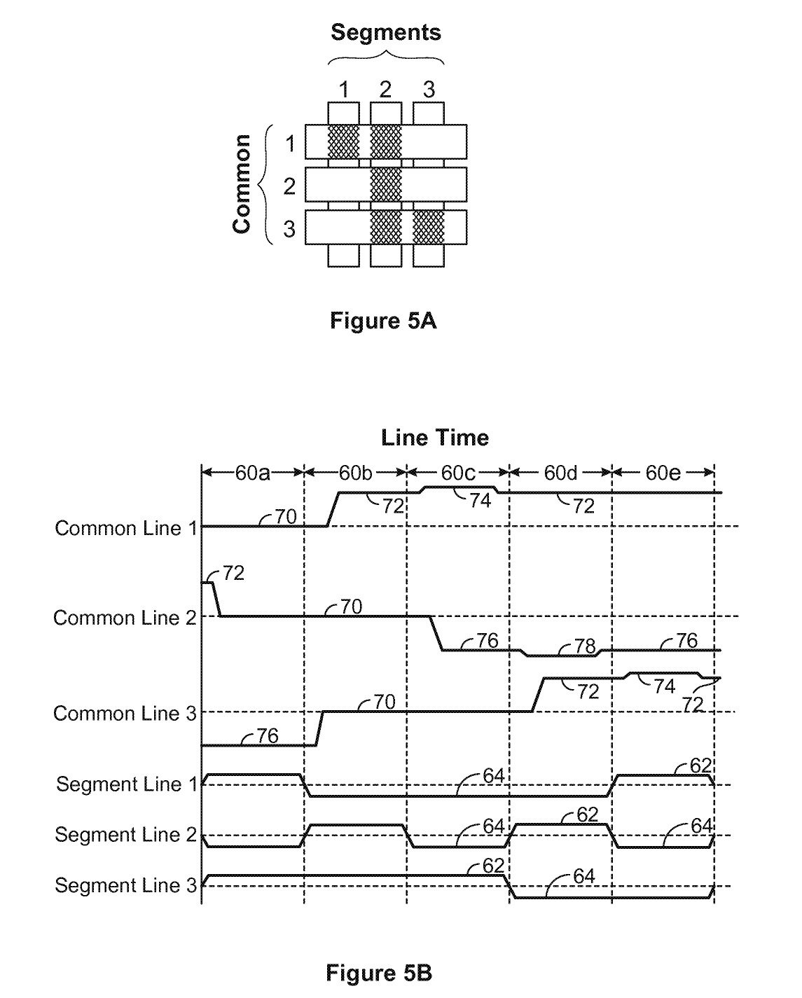

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{D} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a, a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

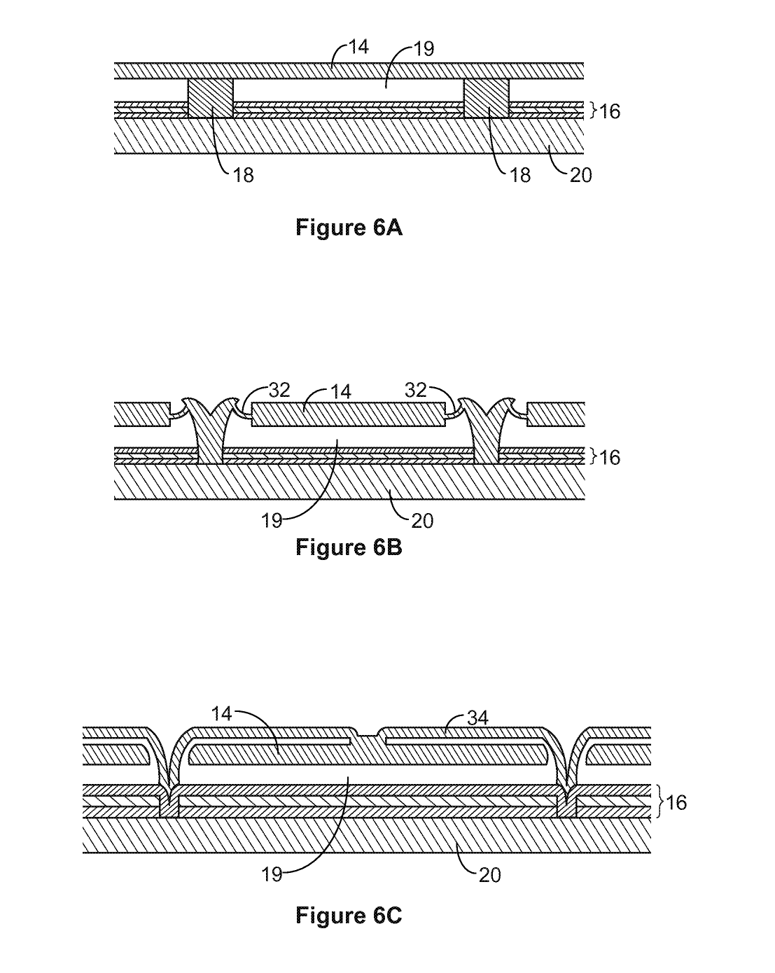

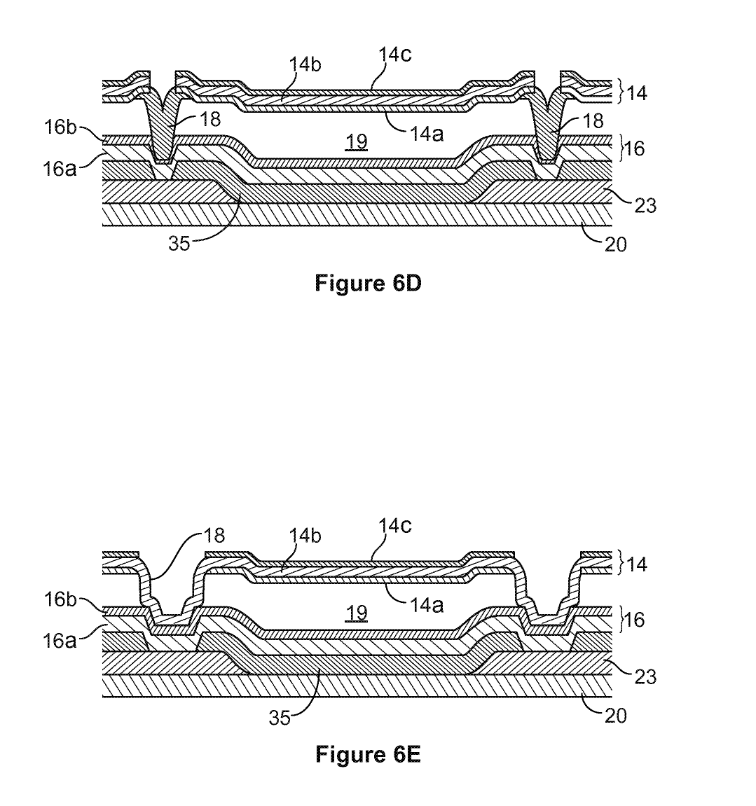

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, an SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self-supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

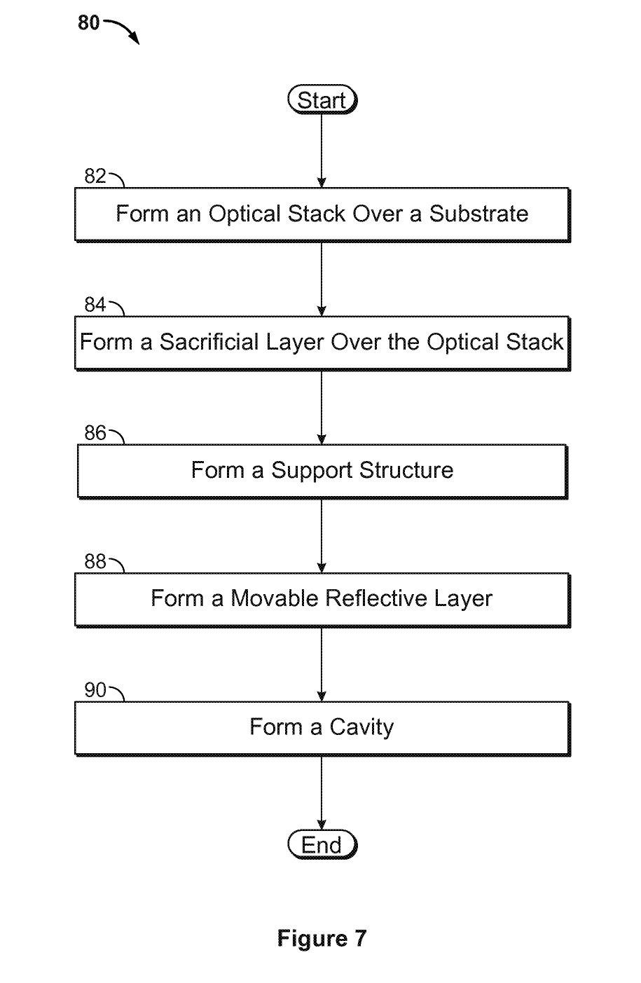

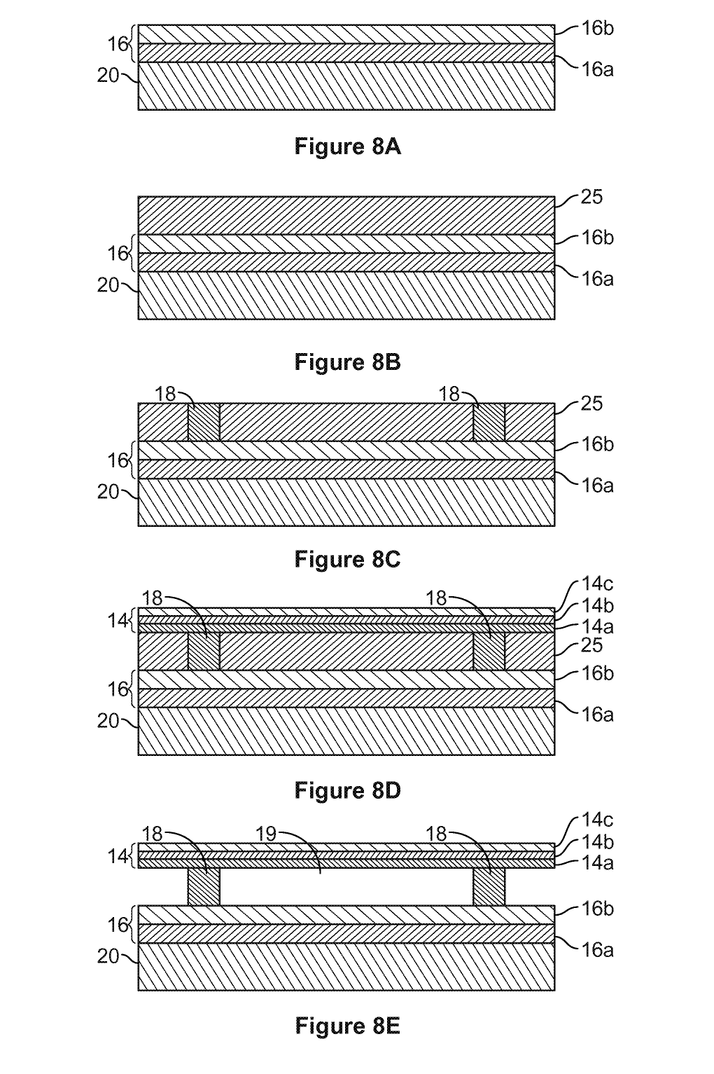

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition processes, e.g., reflective layer (e.g., aluminum, aluminum alloy) deposition, along with one or more patterning, masking, and/or etching processes. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 also may be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other combinations of etchable sacrificial material and etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

Currently, touch sensors made to overlay display devices generally have sensor electrodes made from ITO, because ITO is substantially transparent. Although transparency is a very desirable attribute, ITO has a high resistance compared to some other conductors. The high resistance of ITO places some constraints on touch sensor design. For example, the high resistance of ITO electrodes causes a relatively slower response time than that of metal electrodes and therefore may cause a slower frame rate, particularly for large touch panels. The higher resistance of ITO also causes a higher background capacitance and therefore requires relatively more power for the touch sensor device.

Touch sensors are generally designed such that a position between two sensor electrodes is interpolated in firmware. Such designs may require a relatively small pitch for the sensor electrodes in order to obtain a high level of accuracy for touch sensing, particularly for detecting the location of a stylus tip. However, narrower electrodes are relatively more resistive. Accordingly, the high resistance of ITO can place constraints on the size and the pitch of sensor electrodes.

Some touch sensors described herein may include sensor electrodes that are formed, at least in part, of thin conductive metal wires. However, at least some of the other sensor electrodes may be formed of a non-metallic conductive material, such as ITO. Whether made from ITO or metal wire, the sensor electrodes may not be noticeable to a human observer.

The sensor electrodes may be laid out in a pattern and/or grouped to create a spatial gradient. Some such implementations involve spatial interweaving, spatial interposing and/or length modulation of sensor electrodes. Such implementations can create a spatial gradient such that relatively fewer rows and columns are required to provide a touch sensor panel with a given level of accuracy. Because some of the signal interpolation is due to an inherent gradient caused by the sensor design, signals from fewer nodes need to be processed. Such implementations can reduce computational complexity, memory requirements and power consumption.

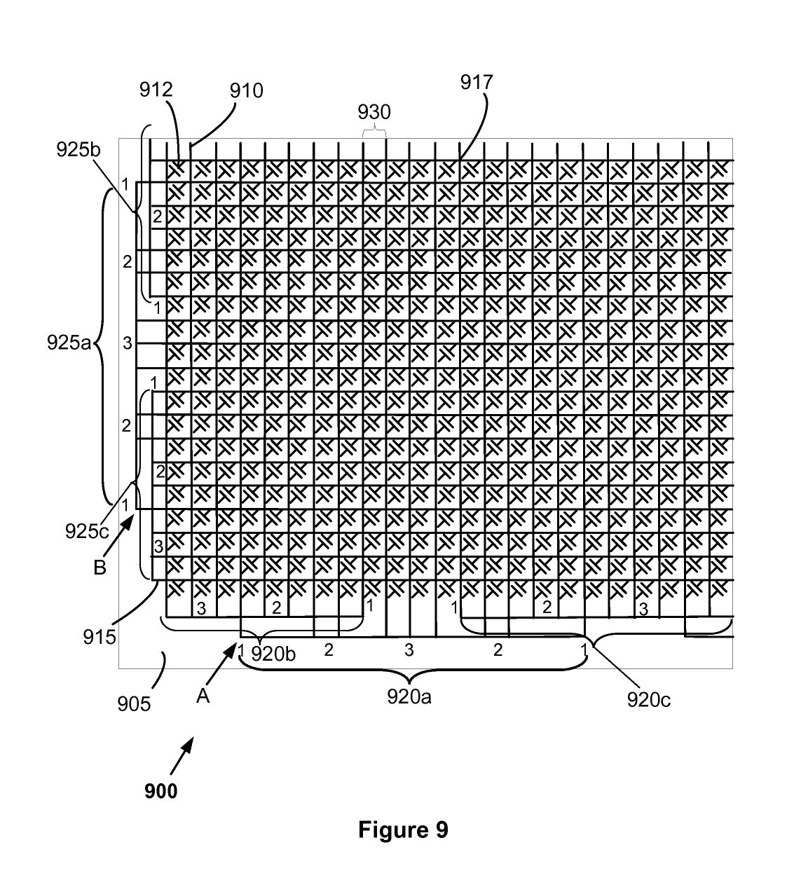

FIG. 9 shows an example of a touch sensor having spatially interposed row electrodes and column electrodes. Only the lower left portion of the touch sensor 900 is shown in FIG. 9. In this implementation, column electrodes 910 and row electrodes 915 are formed on a substantially transparent substrate 905. In some implementations, the substantially transparent substrate 905 may be a cover glass for a display device. In alternative implementations, the substantially transparent substrate 905 may be part of a front light. The substantially transparent substrate 905 may be a single layer or multiple layers, and may be formed of glass, a polymer, and/or other substantially transparent material.

In this example, the column electrodes 910 and the row electrodes 915 are both formed, at least in part, of thin conductive metal wires. In some implementations, the wires may have a thickness that is in a range between 10 nm and a micron. The wires may have a width that is in a range between 100 nm and 10 microns. However the wires may have other dimensions in alternative implementations. The conductive metal may be any suitable conductive metal, such as copper, aluminum, gold, etc. In areas 917 where the column electrodes 910 and the row electrodes 915 overlap, an insulated jumper (not shown) may be used to span one of the electrodes without causing a short circuit. The capacitance symbol 912 depicts the mutual capacitance between one of the column electrodes 910 and one of the nearby row electrodes 915. By detecting changes in the mutual capacitance between rows and columns caused by the presence of a finger or a conductive stylus, the device may function as a touch sensor. In some implementations, the space 930 between the column electrodes 910 or the row electrodes 915 may on the order of a millimeter. For example, in some implementations the space 930 may be on the order of 200 microns to 1.2 mm, e.g. approximately 800 microns.

In this implementation, the group 920a of the column electrodes 910 is spatially interposed with the groups 920b and 920c of the column electrodes 910. In FIG. 9, the column electrodes that constitute each of the groups 920a, 920b and 920c are bounded by curly brackets. In this example, the column electrodes 910 that constitute the group 920a extend further away from the interior of the touch sensor 900. The group 920a includes nine of the column electrodes 910 ganged together in a 1-2-3-2-1 pattern. Alternative implementations may include different numbers of the column electrodes 910 ganged together. The column electrodes 910 may be ganged together in other patterns, such as four of the column electrodes 910 ganged together in a 1-2-1 pattern, eight of the column electrodes 910 ganged together in a 2-4-2 pattern, sixteen of the column electrodes 910 ganged together in a 1-2-3-4-3-2-1 pattern, etc. In some alternative implementations, the column electrodes 910 are not ganged together.

Here, the group 920b is a partial group, having six of the column electrodes 910 ganged together in a 3-2-1 pattern. The group 920c includes nine of the column electrodes 910 ganged together in a 1-2-3-2-1 pattern, but only a portion of the group 920c is shown in FIG. 9.

A close inspection of FIG. 9 will reveal the spatial interposition of the group 920a with the groups 920b and 920c. For example, the left-most single column electrode 910 of the group 920a (see arrow A) is interposed between the left-most three of the column electrodes 910 and the next two of the column electrodes 910 of the group 920b. Two consecutive column electrodes 910 of the group 920a are interposed between a single column electrode 910 and two consecutive column electrodes 910 of the group 920c.

In this implementation, groups of the row electrodes 915 are also spatially interposed with one another. Here, the group 925a of the row electrodes 915 is spatially interposed with the groups 925b and 925c of the row electrodes 915. The group 925a includes nine of the row electrodes 915 ganged together in a 1-2-3-2-1 pattern. Alternative implementations may include different numbers of the row electrodes 915 ganged together. The row electrodes 915 may be ganged together in other patterns, such as those described above with respect to the column electrodes 910. In some alternative implementations, the row electrodes 915 are not ganged together.

Here, the group 925b includes nine of the row electrodes 915 ganged together in a 1-2-3-2-1 pattern, but only a portion of the group 925b is shown in FIG. 9. The group 925c is a partial group, having six of the row electrodes 915 ganged together in a 3-2-1 pattern. In this example, the bottom single row electrode 915 of the group 925a (see arrow B) is interposed between the bottom three of the row electrodes 915 and the next two of the row electrodes 915 in the group 925c. Two consecutive row electrodes 915 of the group 925a are interposed between the lowest single row electrode 915 and the next two consecutive row electrodes 915 in the group 925b.

The width of each of the electrode groups, e.g., the width of the group 920a, may be considered as the width of an individual sensor cell or “sensel.” Spatially interposing the column electrodes 910 and/or the row electrodes 915 provides a linear gradient (hence spatial interpolation) in transitioning from one sensel to another. Such a gradual change in signal while a finger, a conductive stylus, etc., moves from one sensel to another results in relatively better accuracy for determining a touch position for a given sensel pitch.

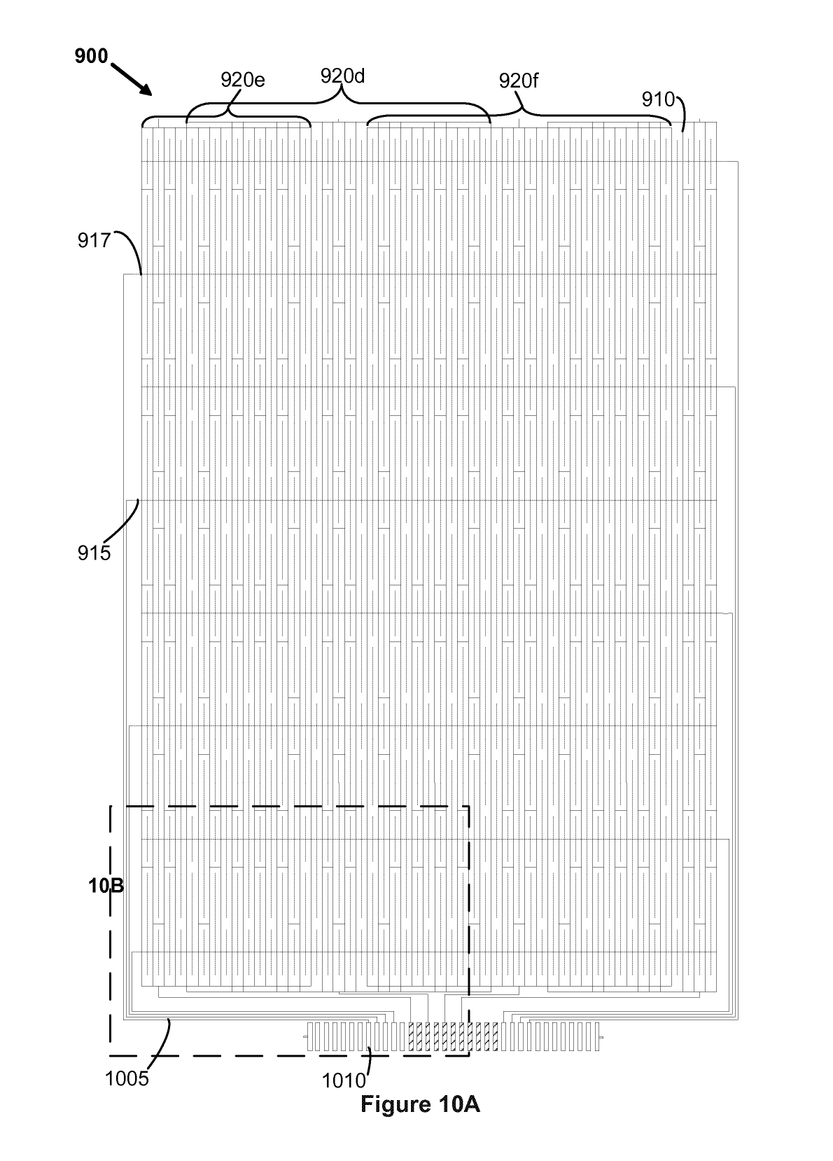

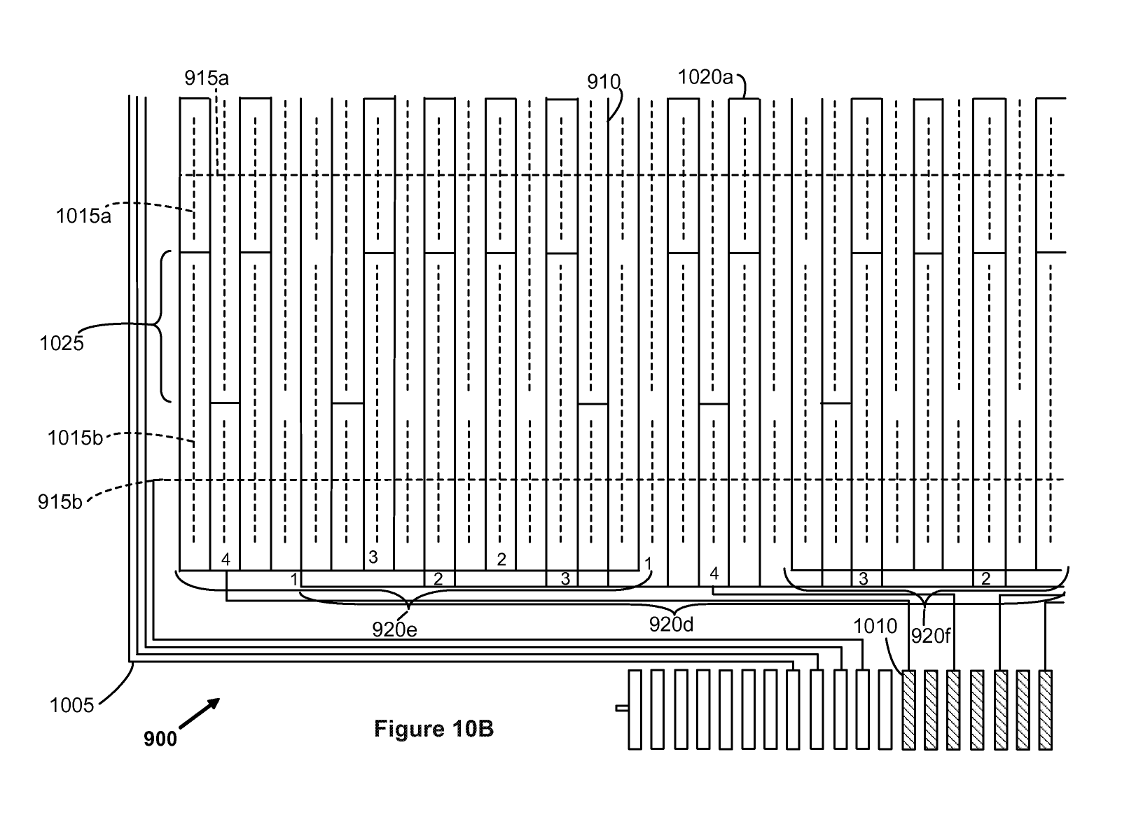

FIG. 10A shows an example of a touch sensor having spatially interwoven row electrodes and spatially interposed column electrodes. FIGS. 10B shows an enlarged portion of the touch sensor example of FIG. 10A. Referring first to FIG. 10A, it may be seen that groups of the column electrodes 910 overlap and are spatially interposed with other groups of the column electrodes 910. Here, the group 920d of the column electrodes 910 is spatially interposed with the groups 920e and 920f of the column electrodes 910. In this example, the row electrodes 915 are not grouped or spatially interposed with one another. The traces 1005 connect the column electrodes 910 and the row electrodes 915 with the bond pads 1010. In some implementations, the bond pads 1010 may be used to connect the traces 1005 with a flex cable and/or with a touch controller, such as the touch controller 77 described below. The dashed rectangle in FIG. 10A indicates the approximate boundary of FIG. 10B.

Referring now to FIG. 10B, it may be more clearly seen how the group 920d of the column electrodes 910 is spatially interposed with the groups 920e and 920f of the column electrodes 910. The group 920d includes 16 of the column electrodes 910 ganged together in a 1-2-3-4-3-2-1 pattern, though not all 16 of the column electrodes 910 are shown in FIG. 10B. Here, the group 920e is a partial group, having ten of the column electrodes 910 ganged together in a 4-3-2-1 pattern. The group 920f includes 16 of the column electrodes 910 ganged together in a 1-2-3-4-3-2-1 pattern, but only a portion of the group 920f is shown in FIG. 10B.

In this example, the left-most single column electrode 910 of the group 920d is interposed between the left-most four of the column electrodes 910 and the next three of the column electrodes 910 of the group 920e. Three consecutive column electrodes 910 of the group 920d are interposed between a single column electrode 910 and the next two consecutive column electrodes 910 of the group 920f. This spatial interposing provides a gradual change in detected mutual capacitance when a finger or a conductive stylus moves from one group of column electrodes to another, providing better touch sensor accuracy for a given pitch of sensor electrodes.

Alternative implementations may include different numbers of the column electrodes 910 ganged together and/or ganged together in other patterns, such as a 1-2-1 pattern, a 2-4-2 pattern, a 1-2-3-2-1 pattern, a 1-2-3-4-5-4-3-2-1 pattern, etc. Other patterns may be used in some implementations, for example a 2-3-1 pattern, a 3-1-5, a 1-3-2-4 and other variations. None-uniform patterns may be used in some implementations, for example a 1-2-3-4-2 pattern, or a 2-4-3-1 pattern, or a 1-2-3-1-2-3 pattern. In some alternative implementations, the column electrodes 910 are not ganged together.

In this implementation, each of the row electrodes 915 has a plurality of row branches that extend laterally from the row electrodes 915 and are spatially interwoven with adjacent row branches of an adjacent row electrode. In this example, the row branches 1015a and 1015b extend laterally from the row electrodes 915a and 915b. Each of the row branches 1015a extends from one of the row electrodes 915 and toward a corresponding row branch 1015b. Similarly, each of the row branches 1015b extends from one of the row electrodes 915 and toward a corresponding row branch 1015a. The spatial interweaving of the row branches 1015a and the row branches 1015b causes a gradual change in the mutual capacitance signal while a finger or a conductive stylus moves from one row to another.

In this implementation, the row branches 1015a are approximately 2 mm long and the row branches 1015b are approximately 5 mm long. The spacing between the row electrodes 915 is approximately 5 mm. The spacing between the column electrodes 910 and the row branches 1015a and 1015b adjacent to the column electrodes 910 is approximately 400 microns. However, this is merely one example. In alternative implementations, there may be different spacings, different numbers of row branches and/or row branches having different lengths. In some such implementations, the row branches may have lengths in the range of 1 to 10 mm. The spacing between the row electrodes 915 may be more or less than 5 mm. In some implementations, the spacing between the row electrodes 915 may be between 1 mm and 10 mm, e.g., approximately 9 mm. In alternative implementations, the spacing between the column electrodes 910 and the adjacent row branches 1015a and 1015b may be in the range of 100 microns to 600 microns.

In this example, the row branches 1015b alternate and create an inter-row area 1025 where approximately 50% of the row branches from the adjacent row electrodes 915 are present. When a finger or conductive stylus is positioned in this inter-row area 1025, approximately 50% of the mutual capacitance signal is contributed by the row electrode 915a and approximately 50% of the mutual capacitance signal is contributed by the row electrode 915b. In this fashion, the physical row pitch needed for a particular level of touch sensor accuracy can be increased, in part because a “logical row” is created by the inter-row areas 1025. In alternative implementations, the inter-row area 1025 may include more or less than 50% of the row branches from the adjacent row electrodes 915, e.g., 25% to 75% of the row branches from the adjacent row electrodes 915.

In this implementation, the row branches 1015a and 1015b do not connect one of the row electrodes 915 to another. However, in this example column branches 1020a extend laterally from some of the column electrodes 910 and connect the column electrodes 910 to adjacent column electrodes 910. Some of the column branches 1020a extend between the row branches 1015a and adjacent row branches 1015b.

In alternative implementations, at least some of the column electrodes 910 also may be spatially interwoven. Moreover, some alternative implementations may include more than 2 different row or column branch lengths.

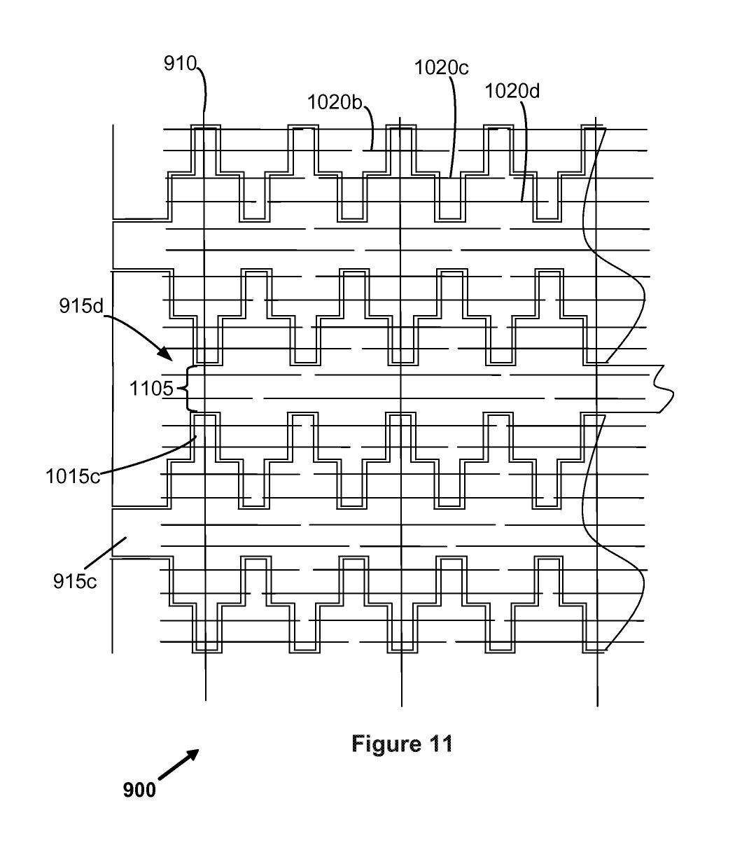

FIG. 11 shows an example of a touch sensor having spatially interwoven row electrodes and column electrodes. In this implementation, the row electrodes 915 are formed of ITO and include row branches that extend into adjacent row electrodes 915. Here, a row branch 1015c extends from a row electrode 915c into a narrow portion 1105 of an adjacent row electrode 915d. In some implementations, the ITO has a thickness in the range of approximately 15 to 200 nm. In some implementations, the narrow portions 1105 may be on the order of a millimeter, e.g., between 0.5 mm and 1.5 mm. In alternative implementations, the narrow portions 1105 may be larger or smaller, e.g., between 3 and 50 microns. The row branches 1015c may be on the on the order of 1 to 10 mm in length, e.g., approximately 5 mm long.

The column electrodes 910 are formed of metal wires in this example. Here, three different lengths of column branches extend laterally from the column electrodes 910. In this example, the column branches 1020b are the shortest, the column branches 1020d are the longest and the column branches 1020c have an intermediate length. In this implementation, the column branches 1020b have a length that is approximately the same as the width of one of the row branches 1015c, the column branches 1020c have a length that is approximately the same as the width of two of the row branches 1015c and the column branches 1020d have a length that is approximately the same as the width of three of the row branches 1015c. However, in other implementations the column branches 1015 may have other lengths. For example, the column branches 1015 may have lengths in the range of 1 to 10 mm. Some alternative implementations may not include column branches 1015. Here, the column branches 1020c are disposed between each of the column branches 1020b and the column branches 1020d, so that the column branch length changes gradually along each of the column electrodes 910.

In some implementations, the ITO that forms the row electrodes 915c and 915d may be on the same side of a substrate as the metal wires that form the column electrodes 910 and the column branches 1020. Such implementations may include an insulating layer between overlapping portions of the metal wires and the ITO. However, in alternative implementations, the row electrodes 915 formed from ITO may be disposed on one side of a substrate and metal wires that form the column electrodes 910 and the column branches 1020 may be formed on a second and opposing side of the substrate.

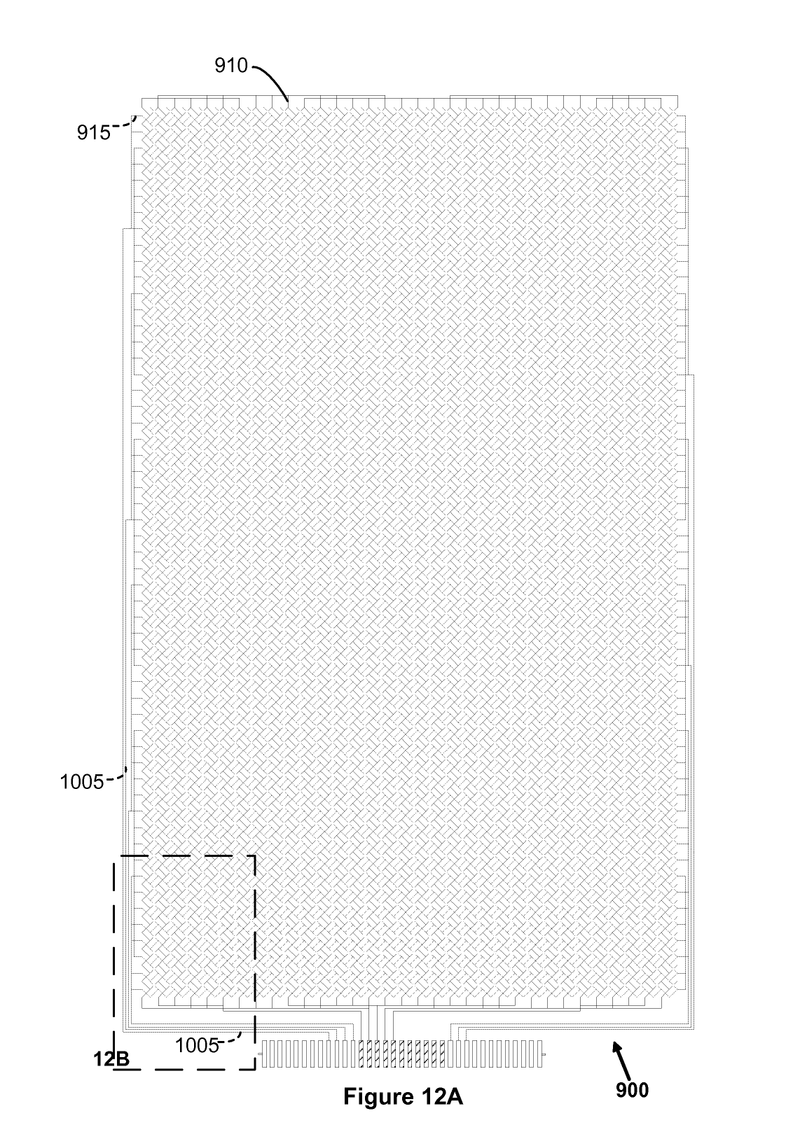

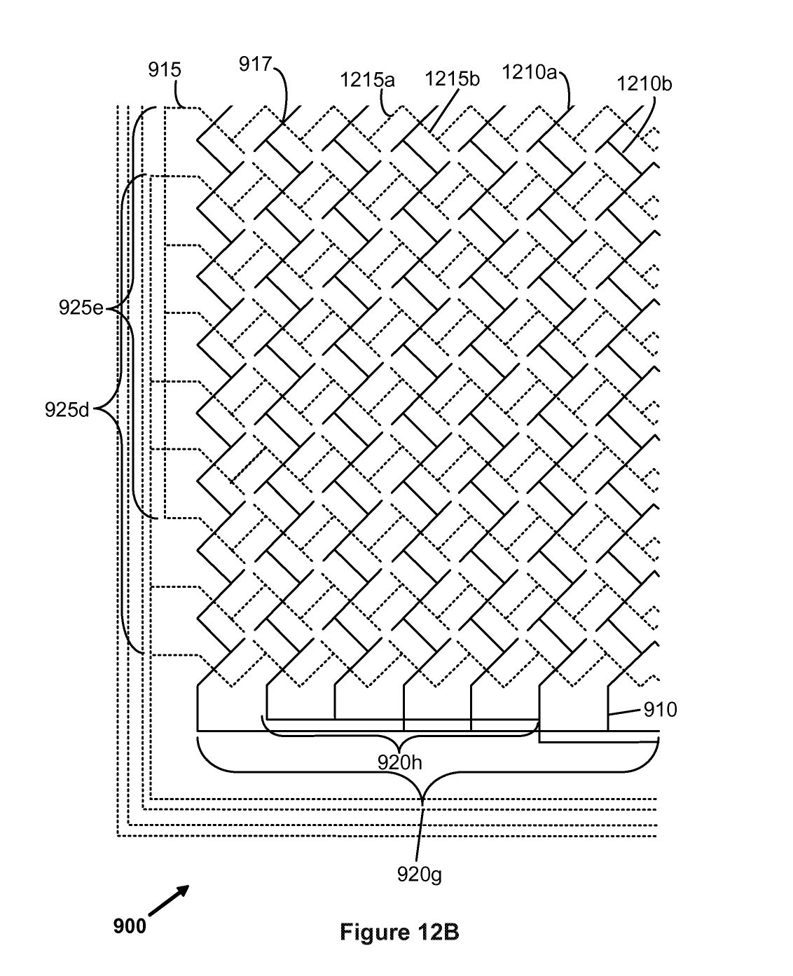

FIG. 12A shows an example of a touch sensor having a mat mosaic design of the row electrodes and the column electrodes. In this implementation of the touch sensor 900, the column electrodes 910 are spatially interposed with adjacent column electrodes 910 and the row electrodes 915 are spatially interposed with adjacent row electrodes 915. Here, both the column electrodes 910 and the row electrodes 915 are formed of metal wire and have portions that are disposed at an angle with respect to the traces 1005. In this example, the angle is approximately 45 degrees. In alternative implementations, such portions of the column electrodes 910 and the row electrodes 915 may be disposed at different angles with respect to the traces 1005, e.g., angles in a range between approximately 30 degrees and 60 degrees.

FIG. 12B shows an enlarged portion of the touch sensor example of FIG. 12A. The column electrodes 910 of the group 920g are spatially interposed with the column electrodes 910 of the group 920h. Similarly, the row electrodes 915 of the group 925d are spatially interposed with the row electrodes 915 of the group 925e.

In this implementation, the column electrodes 910 include portions 1210a and 1210b, and the row electrodes 915 include portions 1215a and 1215b. In this example, the portions 1210a and 1210b of the column electrodes 910 are substantially orthogonal to one another and are substantially parallel to corresponding portions 1215a and 1215b of the row electrodes 915. Similarly, portions 1215a and 1215b of the row electrodes 915 are substantially orthogonal to one another and are substantially parallel to corresponding portions 1210a and 1210b of the column electrodes 910. The portions 1210a and 1210b may, for example, be separated from the adjacent and substantially parallel portions 1215a and 1215b by approximately 100 microns to 600 microns. Insulated jumpers (not shown) prevent short circuits in areas 917 where the column electrodes 910 cross over the row electrodes 915, or vice versa.

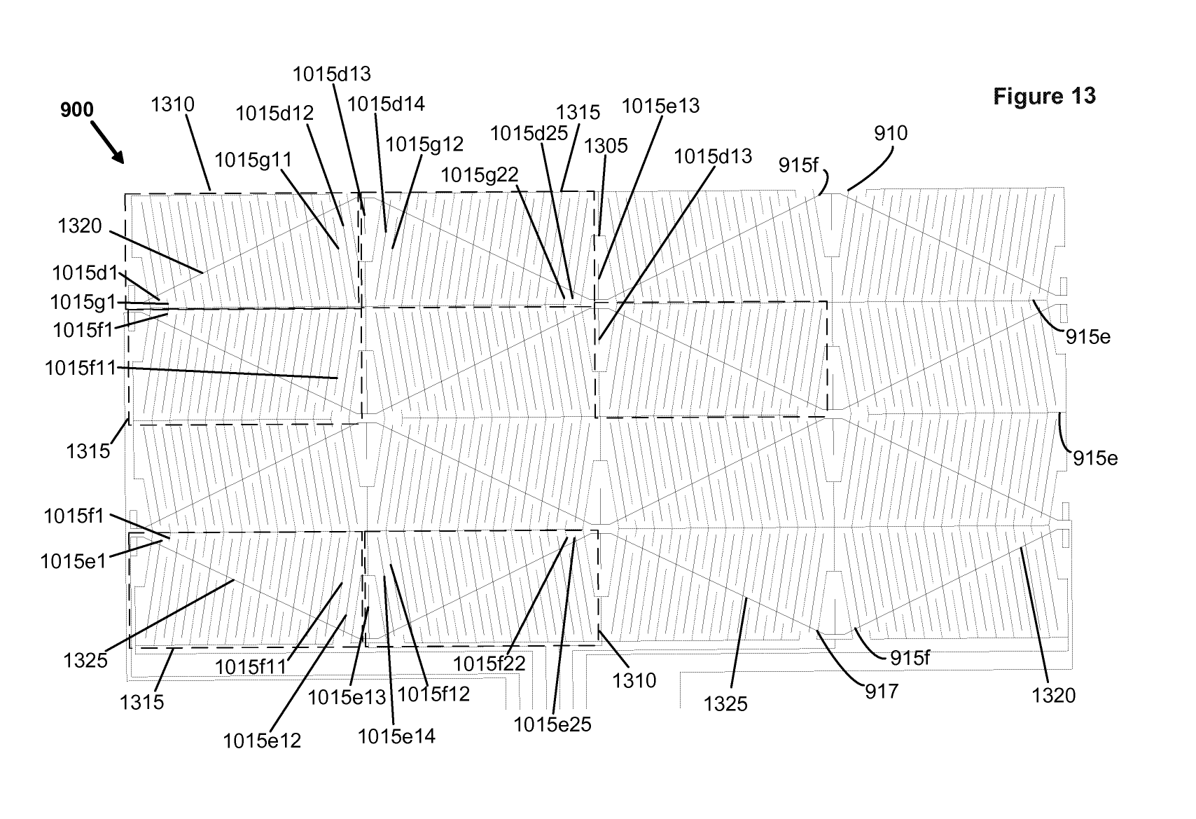

FIG. 13 shows an example of a touch sensor having two sets of spatially interwoven row electrodes. Here, the row electrodes 915e extend across the touch sensor 900 in substantially straight and parallel line segments. In some implementations, the spacing between the row electrodes 915e may be between 1 mm and 10 mm, e.g., approximately 5 or 6 mm. The row electrodes 915f extend across the touch sensor 900 in substantially the same plane as the row electrodes 915e. In this example, the row electrodes 915f include segments 1320 and segments 1325. The segments 1320 are substantially parallel with one another. The segments 1325 also are substantially parallel with one another. However, the segments 1320 are disposed at an angle from the segments 1325. Accordingly, there is a variable distance between the row electrodes 915e and the row electrodes 915f.

The areas 1310 include the segments 1320. The areas 1315, which are adjacent to the areas 1310, include the segments 1325. In the areas 1310 and the areas 1315, the row branches 1015d extend from a first side of the row electrodes 915f and the row branches 1015e extend from a second side of the row electrodes 915f. The row branches 1015e are adjacent to the row branches 1015f that extend laterally from one of the row electrodes 915e. Similarly, the row branches 1015d are adjacent to the row branches 1015g that extend laterally from another of the row electrodes 915e. The spacing between adjacent row branches (e.g., between the row branches 1015d and the row branches 1015g) may be on the order of 100 to 600 microns.

In this example, the lengths of the row branches 1015d are proportional to the lengths of the row branches 1015g. For example, referring to the area 1310 in the upper left corner of FIG. 13, the row branch 1015d1 is the smallest of the row branches 1015d in the area 1310 and the row branch 1015g1, adjacent to the row branch 1015d1, is the smallest of the row branches 1015g in the area 1310. The row branches 1015d gradually increase in length from the row branch 1015d1 to the row branch 1015d12, whereas the adjacent row branches 1015g gradually increase in length from the row branch 1015g1 to the row branch 1015g11. In the adjacent area 1315, the row branches 1015d gradually decrease in length from the row branch 1015d14 to the row branch 1015d25, whereas the adjacent row branches 1015g gradually decrease in length from the row branch 1015g12 to the row branch 1015g22. In some implementations, the smallest row branches (e.g., the row branch 1015d1) may be less than a micron in length (e.g., approximately 0.5 microns) and the longest row branches (e.g., the row branch 1015d12) may be on the order of 5 to 10 microns (e.g., approximately 4 microns).

Referring now to the area 1315 in the lower left of FIG. 13, the row branch 1015e1 is the smallest of the row branches 1015e in the area 1315 and the row branch 1015f1, adjacent to the row branch 1015e1, is the smallest of the row branches 1015f in the area 1315. The row branches 1015e gradually increase in length from the row branch 1015e1 to the row branch 1015e12, whereas the adjacent row branches 1015f gradually increase in length from the row branch 1015f1 to the row branch 1015f11. In the adjacent area 1310, the row branches 1015e gradually decrease in length from the row branch 1015e14 to the row branch 1015e25, whereas the adjacent row branches 1015f gradually decrease in length from the row branch 1015f12 to the row branch 1015f22.

In this example, the lengths of the row branches on one side of the row electrodes 915f are inversely proportional to the lengths of the row branches on the other side of the row electrodes 915f. For example, within the areas 1310, the row branches 1015d1 through 1015d12 are progressively longer, whereas the row branches 1015e14 through 1015e25 are progressively shorter. Within the areas 1315, the row branches 1015d14 through 1015d25 are progressively shorter, whereas the row branches 1015e1 through 1015e12 are progressively longer.

However, the lengths of the row branches on one side of the row electrodes 915e are proportional to the lengths of the row branches on the other side of the row electrodes 915e. For example, within the upper left area 1310, the row branches 1015g1 through 1015g11 are progressively longer. In the area 1315 just below the upper left area 1310, the row branches 1015f1 through 1015f11, extending from the same one of the electrodes 915e, also are progressively longer.

In this implementation, the row electrodes 915e are connected to the column electrodes 910. The column electrodes 910 include the loops 1305, which may enclose one or more row branches extending from the row electrodes 915f. For example, the loop 1305 that is adjacent to the upper left area 1315 includes the row branches 1015d13 and 1015e13. The loop 1305 that spans the lower left areas 1310 and 1315 includes one of the row branches 1015e13. Because the row electrodes 915e and 915f, as well as the column electrodes 910, are substantially in the same plane in this example, an insulated jumper (not shown) may be used to prevent a short circuit in areas 917 where the column electrodes 910 cross the row electrodes 915f.

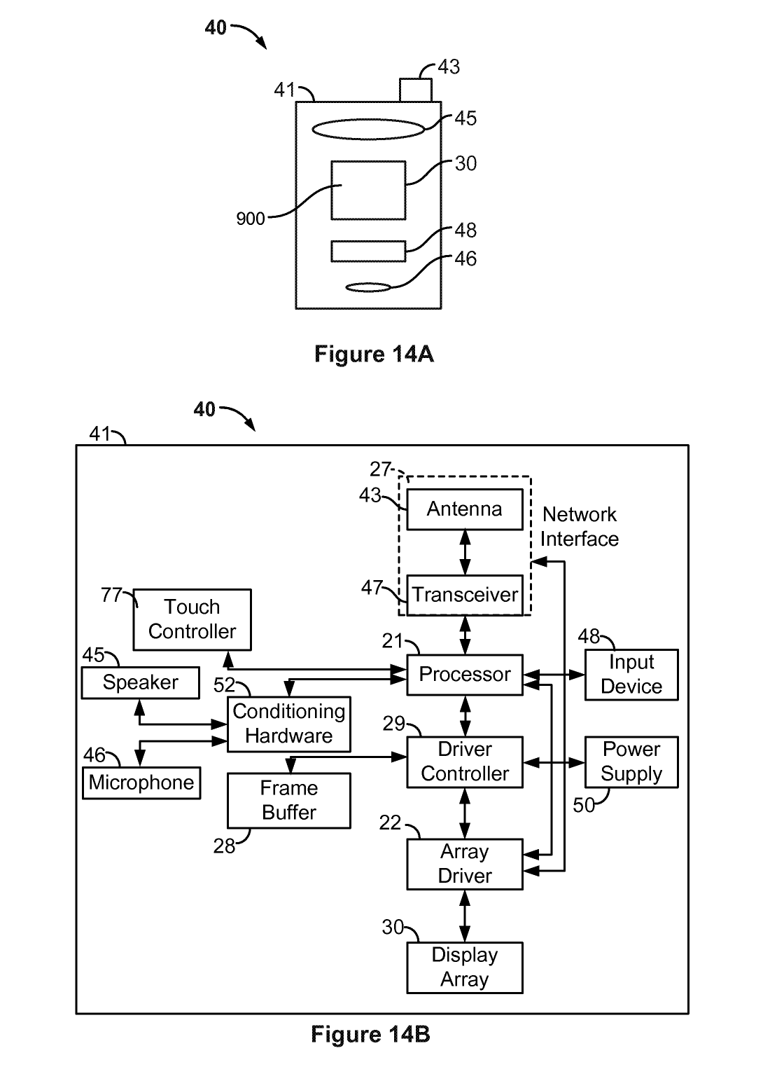

FIGS. 14A and 14B show examples of system block diagrams illustrating a display device that includes a touch sensor as described herein. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, a touch sensor device 900, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein. The touch sensor device 900 may be a device substantially as described herein.

The components of the display device 40 are schematically illustrated in FIG. 21B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

In this example, the display device 40 also includes a touch controller 77. The touch controller 77 may be configured for communication with the touch sensor device 900 and/or configured for controlling the touch sensor device 900. The touch controller 77 may be configured to determine a touch location of a finger, a conductive stylus, etc., proximate the touch sensor device 900. The touch controller 77 may be configured to make such determinations based, at least in part, on detected changes in capacitance in the vicinity of the touch location. In alternative implementations, however, the processor 21 (or another such device) may be configured to provide some or all of this functionality.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43. The processor 21 may be configured to receive time data, e.g., from a time server, via the network interface 27.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone integrated circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD (or any other device) as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A touch sensor device, comprising:
a plurality of row electrodes formed substantially in a plane, each row electrode of the plurality of row electrodes having a plurality of row branches extending laterally from the row electrode, the row branches being spatially interwoven with adjacent row branches of an adjacent row electrode; and
a plurality of column electrodes formed substantially in the plane, wherein first groups of the plurality of column electrodes are ganged together and spatially interposed with second groups of the plurality of column electrodes, and wherein at least some of the column electrodes include column branches that extend laterally from a first column electrode and between adjacent row branches.

2. The touch sensor device of claim 1, wherein the column branches connect the first column electrode to a second column electrode.

3. The touch sensor device of claim 1, wherein a first plurality of the row branches has a first length and a second plurality of the row branches has a second length.

4. The touch sensor device of claim 1, wherein the first and second groups of column electrodes are grouped in a 1-2-1 pattern, a 2-4-2 pattern, a 1-2-3-2-1 pattern or a 1-2-3-4-3-2-1 pattern.

5. The touch sensor device of claim 1, wherein the plurality of row electrodes is formed, at least in part, of metal wire.

6. The touch sensor device of claim 1, wherein the plurality of column electrodes is formed, at least in part, of metal wire.

7. The touch sensor device of claim 1, wherein the plurality of row electrodes is formed of indium tin oxide.

8. The apparatus of claim 1, further comprising:
a display;
a processor that is configured to communicate with the display, the processor being configured to process image data; and
a memory device that is configured to communicate with the processor.

9. The apparatus of claim 8, further comprising:
a driver circuit configured to send at least one signal to the display; and
a controller configured to send at least a portion of the image data to the driver circuit.

10. The apparatus of claim 8, further comprising:
an image source module configured to send the image data to the processor.

11. The apparatus of claim 10, wherein the image source module includes at least one of a receiver, transceiver, and transmitter.

12. The apparatus of claim 8, further comprising:
an input device configured to receive input data and to communicate the input data to the processor.

13. The apparatus of claim 8, further comprising:
a touch controller configured for communication with the processor; and
routing wires configured for connecting the row electrodes and the column electrodes with the touch controller.

14. A touch sensor device, comprising:
row electrode means formed substantially in the plane, each row electrode of the row electrode means having a plurality of row branches extending laterally from the row electrode, the row branches being spatially interwoven with adjacent row branches of an adjacent row electrode; and
column electrode means formed substantially in a plane, wherein first groups of the plurality of column electrodes are ganged together and spatially interposed with second groups of the plurality of column electrodes, and wherein at least some of the column electrodes of the column electrode means include column branches that extend laterally from a first column electrode and between adjacent row branches.

15. The touch sensor device of claim 14, wherein the column branches connect the first column electrode to a second column electrode.

16. The touch sensor device of claim 14, wherein a first plurality of the row branches has a first length and a second plurality of the row branches has a second length.

17. The touch sensor device of claim 14, wherein the first and second groups of column electrodes are grouped in a 1-2-1 pattern, a 2-4-2 pattern, a 1-2-3-2-1 pattern or a 1-2-3-4-3-2-1 pattern.

18. The touch sensor device of claim 14, wherein at least one of the row electrode means and the column electrode means is formed, at least in part, of metal wire.

19. The touch sensor device of claim 14, wherein the row electrode means is formed of indium tin oxide.

20. A touch sensor device, comprising:
a first plurality of row electrodes formed substantially in a plane, each first row electrode of the plurality of first row electrodes having a plurality of first row branches extending laterally from the first row electrode; and
a second plurality of row electrodes formed substantially in the plane, each second row electrode of the plurality of second row electrodes having a plurality of second row branches extending laterally from the second row electrode, the second row branches being spatially interwoven with adjacent first row branches of an adjacent first row electrode, the first row branches having a plurality of first row branch lengths, wherein at least some of the first row branch lengths vary proportionally with second row branch lengths of adjacent second row branches.

21. The touch sensor device of claim 20, wherein there is a variable distance between the first plurality of row electrodes and the second plurality of row electrodes.

22. The touch sensor device of claim 20, wherein the first plurality of row electrodes include substantially parallel line segments.

23. The touch sensor device of claim 20, wherein the second plurality of row electrodes includes first substantially parallel line segments and second substantially parallel line segments, the first substantially parallel line segments being disposed at an angle from the second substantially parallel line segments.

24. The touch sensor device of claim 23, further comprising:
first areas that include the first substantially parallel line segments; and
second areas adjacent to the first areas, the second areas including the second substantially parallel line segments.

25. The touch sensor device of claim 20, wherein the first row branches extend from the first plurality of row electrodes on a first side and a second side, and wherein the first row branches on the first side have first lengths that are proportional to second lengths of the first row branches on the second side.

26. The touch sensor device of claim 20, wherein the second row branches extend from the second plurality of row electrodes on a first side and a second side, and wherein the second row branches on the first side have first lengths that are inversely proportional to second lengths of the second row branches on the second side.

27. The touch sensor device of claim 20, further including a plurality of column electrodes, wherein at least some of the first plurality of row electrodes are connected to the column electrodes.

28. The touch sensor device of claim 27, wherein the first plurality of row electrodes, the second plurality of row electrodes and the plurality of column electrodes are formed, at least in part, of metal wire.

29. The touch sensor device of claim 27, wherein the plurality of column electrodes include loops.

30. The touch sensor device of claim 29, wherein the loops enclose at least one of the second row branches.

31. A touch sensor device, comprising:
first row electrode means formed substantially in a plane, each first row electrode of the row electrode means having a plurality of first row branches extending laterally from the first row electrode; and
second row electrode means formed substantially in the plane, each second row electrode of the second row electrode means having a plurality of second row branches extending laterally from the second row electrode, the second row branches being spatially interwoven with adjacent first row branches of an adjacent first row electrode, the first row branches having a plurality of first row branch lengths, wherein at least some of the first row branch lengths vary proportionally with second row branch lengths of adjacent second row branches.

32. The touch sensor device of claim 31, wherein there is a variable distance between the first row electrode means and the second row electrode means.

33. The touch sensor device of claim 31, wherein the first row electrode means extends across the touch sensor device in substantially parallel line segments.

34. The touch sensor device of claim 31, wherein the second row electrode means includes first substantially parallel line segments and second substantially parallel line segments, the first substantially parallel line segments being disposed at an angle from the second substantially parallel line segments.
